(19) United States
(12) Patent Application Publication
(10) Pub. No.: US 2003/0111171 A1
(43) Pub. Date: Jun. 19, 2003

(54) Poly(trimethylene) terephthalate texile staple production

(76) Inventors: Paul Karol Casey, Katy, TX (US); Kailash Dangayach, Houston, TX (US); Linda Harvey Oliveri, Katy, TX (US); Donald Albert Shiffler, Kinston, NC (US)

Correspondence Address: Donald F Haas, Shell Oil Company, Intellectual Property, PO Box 2463, Houston, TX, 77252-2463, US

(21) Appl. No.: 10/221,067

(22) PCT Filed: Mar. 15, 2001
(86) PCT No.: PCT/US01/08230

(51) Int. Cl. B31D 1/00; B32B 17/00

(52) U.S. Cl. 156/296; 156/167; 156/62.2

(57) ABSTRACT

A process for making textile staple fibre from polytrimethylene terephthalate (PTT) which comprises: (a) melt extruding PTT polymer at 245 to 253° C., (b) spinning the extruded PTT into yarn using at least one spinneret, (c) moving the spun yarn to a first takeup roll wherein the distance from the spinneret to the roll is from 16 to 20 feet, (d) cooling the spun yarn to less than 31° C. before it reaches the roll, (e) prior to the draw process, preconditioning the yarn under tension at a temperature of at least 60° C., (f) drawing the yarn at a temperature of at least 60° C., (g) allowing the drawn yarn to relax at a temperature of up to 190° C., and (h) crimping the drawn yarn at a temperature of 70 to 120° C., and decreasing the drawn yarn feed denier into the crimper by 10 to 60 percent by denier.

### FIELD OF THE INVENTION

Poly(trimethylene terephthalate) polymer is a new polyester resin suitable for use in carpet, textile, and other thermoplastic resin applications. Poly(trimethylene terephthalate) (PTT) is chemically an aromatic polyester resin made by the polycondensation of 1,3-propanediol (PDO) and terephthalic acid. Production of textile staple from PTT is possible on a wide variety of commercial processing equipment.

### BACKGROUND OF THE INVENTION

PET synthetic fiber staple production is often decoupled two-stage process. The first stage involves extrusion of Un-Drawn Yarn, which is stored for draw processing in the second stage. There are two main types of draw processes used in staple production Draw-Relax and Draw Anneal. The fundamental difference between these two processes is how fiber shrinkage is managed. In draw relax staple production the shrinkage strategy is to pre-shrink the fibers in an oven after crimping to desired performance and properties. In draw annealed staple production the shrinkage strategy is heat the fibers allowing for constant length crystallization before crimping.

Staple fibre from polyethylene terephthalate (PET) has been produced and there are well established processes for doing so. It would be desirable to be able to produce PTT staple fibre on existing equipment. However, there are many differences between the two polymers which make the production of commercially useful staple fiber of PTT on existing staple production equipment difficult or unlikely. To understand how to produce PTT staple on existing equipment one needs to address several process questions:

How do you characterize the draw behavior of undrawn yarn? How does the draw behavior of undrawn yarn change over time? As described in Example #1.

How do you control the properties of undrawn Yarn during extrusion? As described in Example #2.

What is the typical draw performance for the undrawn yarn. As described in Example #3 and Example #4.

How does one control fiber shrinkage during undrawn Yarn production and storage as described in Example #5.

How do you control fiber shrinkage during the staple draw and in the final staple products? As described in Example #6.

How does one crimp the fiber to provide texture and cohesion in downstream commercial processes for staple textile spun yarns and non-wovens? As described in Example #7

How do you heat set and control the youngs modulus and stretch properties of the staple fiber. How do the staple fiber properties impact the properties of spun yarns? As described in Example #8.

What is a basic process to produce staple on existing equipment that addresses the interdependent nature of the first six process questions discussed above. Such a process is provided by the present invention.

### SUMMARY OF THE INVENTION

The present invention describes a two-stage staple production process using PTT. The first stage is extrusion of undrawn yarn (UDY). UDY is converted to a staple fibre product in the second draw production stage.

In accordance with the present invention there is provided a process for making textile staple fibre from polytrimethylene terephthalate (PTT) on existing PET textile staple fibre making equipment which comprises: (a) melt extruding PTT polymer at 245 to 253° C., preferably 245 to 250° C., (b) spinning the extruded PTT into yarn using at least one spinneret, (c) moving the spun yarn to a first takeup roll wherein the distance from the spinneret to the first takeup roll is from 16 to 20 feet, (d) cooling the spun yarn to less than 31° C., preferably less than 25 C., more preferably less than 20 C., before it reaches the first takeup roll, (e) optionally, storing the spun yarn in a climate controlled room at a temperature of no more than 31° C. (both this step and the previous one are carried out to minimize premature shrinkage of the undrawn yarn prior to draw processing), (f) prior to the draw process, preconditioning the yarn under tension at a temperature of at least 60° C., preferably 60 to 100° C., (g) drawing the yarn at a temperature of at least 60° C., preferably 60 to 100° C., with an optional preferred second draw wherein the majority of the total draw occurs in the first draw, most preferably 80 to 85% of the total draw, and wherein the second and subsequent draws are carried out at a temperature above the temperature of the first draw up to a practical maximum of the melting point of the yarn, preferably 60 to 160° C., most preferably at a temperature of 80 to 100° C., (h) allowing the drawn yarn to relax at a temperature of up to 190° C., preferably 100 to 140° C. (the relaxation can be from 2 to 25% or possibly more but is preferably 2 to 10%) in order to achieve an increase in the initial Young's modulus of the drawn yarn, and (i) crimping the drawn yarn at a temperature of 70 to 120° C., preferably 80 to 120° C. if the relaxation step is used and 70 to 100° C. if it is not used, and decreasing the drawn yarn feed denier into the crimper by 10 to 60 percent by denier, preferably 40 to 60 percent, from the drawn yarn feed rate used for making comparable PET staple in the existing equipment. Also, alternatively or in combination, the volume of the crimper may be increased 10 to 50, preferably 20 to 35 percent more than the crimper volume used to make PET in the existing equipment. Preferably, the choice of conditions is based on the particular equipment and the desired yield.

### BRIEF DESCRIPTION OF THE DRAWINGS

The present invention will now be described by way of example with reference to the accompanying drawings, in which:

FIG. 1 is a schematic of the process steps from resin to baled fibre whose critical elements will be described.

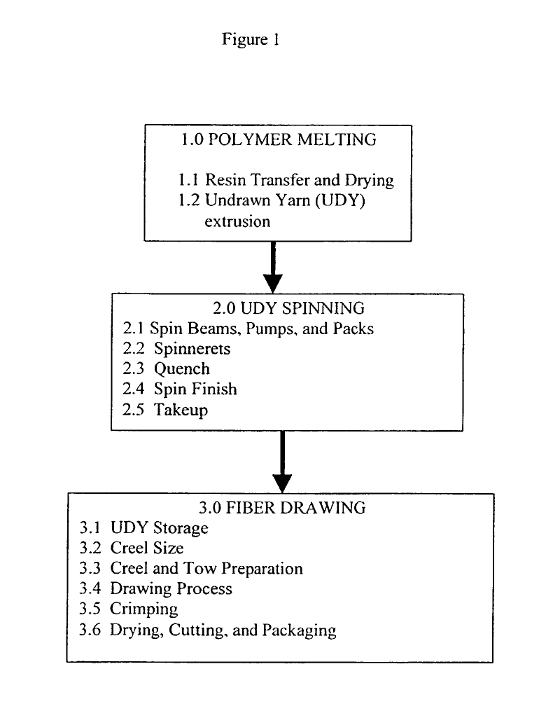

FIG. 2 is the tenacity elongation balance curve useful in helping assess the possible range of staple properties for PTT.

FIG. 3 shows a typical Stress/Strain Curve for as Spun Yarn Bundles.

FIG. 4 shows the effect of extrusion temperature on fiber drawability.

FIG. 5 shows the undrawn yarn shrinkage in water of different temperatures as a function of undrawn yarn spinning conditions.

FIG. 6 shows the orientation schematic describing the effect of fiber shrinkage.

FIG. 7 shows the effect of draw bath temperature and total orientation parameter on boil off shrinkage;

FIG. 8 shows the effect of draw bath temperature and total orientation parameter on 125° C. dry heat shrinkage.

FIG. 9 shows the effect of draw bath temperature and total orientation parameter on 140° C. dry heat shrinkage.

FIG. 10 shows the effect of draw bath temperature and total orientation parameter on 175° C. dry heat shrinkage.

FIG. 11 shows the effect of draw bath temperature and total orientation parameter on 197° C. dry heat shrinkage.

FIG. 12 shows the effect of draw ratio and draw bath temperature on draw process relaxation factor.

FIG. 13 shows the predicted dry heat shrinkage as a function of drier (relaxer) oven temperature for free relax 1.4 Total Orientation Parameter and 75° C. draw bath temperature.

FIG. 14 shows the effect of relaxer oven temperature and applied yarn stretch on 175° C. dry heat shrinkage for 100% PTT yarns.

FIG. 15 shows the effect of relaxer oven temperature and applied yarn stretch on 175° C. dry heat shrinkage for 100% PET yarns.

FIG. 16 shows the comparison of PTT and PET spun yarn 175° C. dry heat shrinkage at two yarn heat set temperatures.

FIG. 17 shows the effect of relaxer oven temperature and applied yarn stretch on 175° C. dry heat shrinkage for 50:50 PTT:Cotton yarns.

FIG. 18 shows the comparison of PTT and PET spun yarn boil off shrinkage at two heat set temperatures.

FIG. 19 shows the comparison of PTT and PET spun yarn load at 5% strain at two yarn heat set temperatures.

FIG. 20 shows the comparison of PTT and PET spun yarn 2 minute percent stress decay at two spun yarn heat set temperatures.

FIG. 21 shows the comparison of PTT and PET spun yarn percent strain recovery (2 minute extension) at two spun yarn heat set temperatures.

### DETAILED DESCRIPTION OF THE INVENTION

Polymer textile staple is feasible using existing facilities. Since the equipment used by different companies varies greatly, there will be differences in how the processes are carried out. Once the staple producer tailors its settings to the unique properties of PTT, it is possible to produce a wide variety of staple products suitable for use in spun yarn and non-woven textiles. Textile staple produced from PTT offers excellent loft and drape providing softness, bulk, compatibility in blends, easy-care, and shape retention in textile products.

1.0 POLYMER MELTING

1.1 Resin Transfer and Drying

Low energy air conveying systems minimize dust formation when transferring resin from shipping containers, processing equipment and storage facilities. Before extrusion, PTT resin should be dried to a constant moisture level of 50 ppm or less. This moisture specification minimizes the impact of resin degradation by hydrolysis during melt spinning. Many types of commercial dryers using desiccated air have successfully met this requirement. Dryers equipped with molecular sieves (13X & 4A), vacuum systems, and lithium chloride desiccants have met moisture requirements in commercial production. When possible, it is preferable to dry the polymer using 13X molecular sieve desiccated air (dew point of −40° C. or less) heated to 130° C. with 4-6 hours of drying time. Using dry air when transferring dried resin from the dryer to the extruder is essential to minimize hydrolysis during melt spinning.

In large commercial dryers, drying PTT at rates that can keep pace with extrusion throughput may be challenging. In this situation higher dryer temperatures may be needed. The PTT dryer air temperature should not exceed 165° C. Dryer residence time should not exceed 4 hours when using 165° C. air.

1.2 Undrawn Yarn (UDY) Extrusion

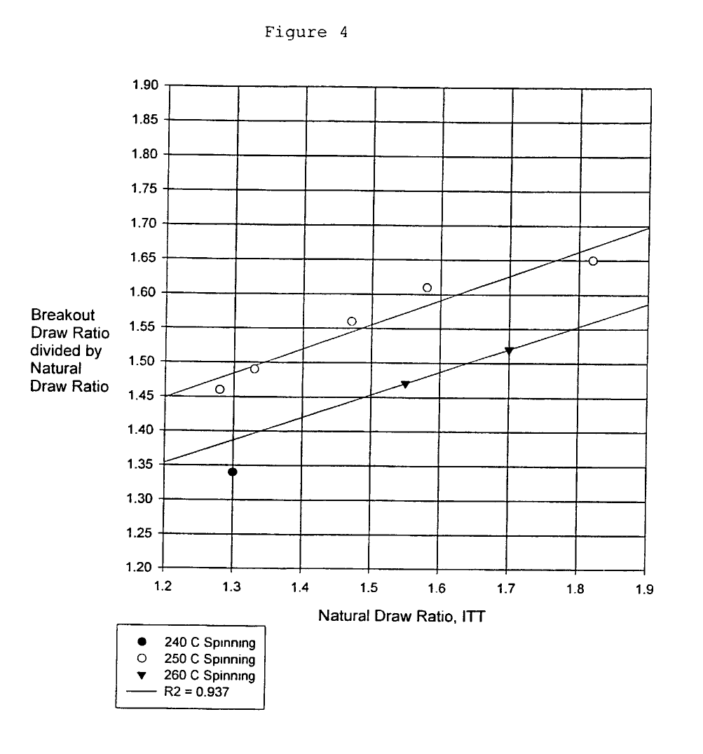

A typical melt preparation system includes an extruder, spin beam, melt pump, and spin pack. The key is to establish a uniform, optimum polymer melt viscosity by minimizing melt process temperature and residence time. Commercial production of PTT UDY with both twin screw and single screw extruders is straightforward. In twin screw extruders it may be necessary to reduce the extruder melt pressure by as much as 25-50% (from PET conditions) to avoid excessive shear degradation of the polymer melt. Commercial production of PTT UDY uses extruder melt temperatures ranging from 245° C. to 270° C. Care must be taken when producing PTT UDY at melt temperatures between 260 to 270° C. to avoid excessive degradation of polymer melt and subsequent UDY properties. The optimal staple extrusion melt temperature for PTT is 245 to 253° C., preferably 245 to 250° C. Future PTT resins with lower intrinsic viscosity will likely require lower temperatures. FIG. 4 shows that better drawability is obtained when the polymer is extruded at 250° C. rather than at 240° C. or 260° C.

2.0 UNDRAWN YARN (UDY) SPINNING

2.1 Spin Beams, Pumps, and Packs

Trials using mono-component and bi-component extrusion systems to produce PTT staple UDY were successful. Spin pump volume and revolution control systems sized for PET usually meet the lower through put per position requirement for PTT staple. The filtration media should have minimum pore size of 30 microns. Often commercial spin packs use a minimum amount of filtration media. In the early stages of developing a PTT staple production process, it is preferable to use a standard filtration depth of medium/course sand (90/120 mesh). Evaluation of filament diameter uniformity will help determine if spin pack filtration or extrusion system melt pressure need optimization.

Staple extrusion systems are engineered for a specific range of resin viscosity, throughput, melt temperature, and residence time. In general, the hole-throughput needed to make PTT staple is usually 20-30% lower than that for PET products of comparable denier. This essentially increases the residence time for PTT extruded with PET staple production equipment. The increase in melt residence time can lead to degradation if melt temperatures are higher than 260° C. Transfer line and spin beam heating systems should equal the extruder outlet polymer temperature if possible.

2.2 Spinnerets

Spinneret selection depends on the target product denier and is determined by the limiting throughput per hole-minute for stable melt spinning. In general PTT staple can use standard PET spinneret designs for similar products. However, PTT staple generally requires smaller capillary diametres for low denier products when compared to PET staple production. PTT resins have an upper shear rate limit of 7500-9000 reciprocal seconds for round cross sections depending on melt extrusion conditions.

Spinneret selection based on target staple product denier is shown in Table I.

TABLE I
Spinneret Selection Chart

| | 1.0-1.3 | 1.30-1.75 | 1.40-1.85 |
|---|---|---|---|
| Fine Denier Range at 1100 m/min | dpf | dpf | dpf |
| Spinneret diameter (mm) | 0.23 | 0.25 | 0.35 |
| Spinneret l/d | 1.85 | 1.85 | 1.85-2.0 |
| Limiting Throughput per hole | 0.32 | 0.41 | 0.45 |

It is important that a long fibre culmination zone (the distance from the spinneret to the take up roll) be used. This means that the zone should be 16 to 20 feet rather than the standard 8 to 12 feet for PET. In process shrinkage of PTT UDY is relatively high so the process must allow the fibre to establish a stable molecular structure before all of the filaments are combined into one large draw process feed yarn. In the production of PET staple fibre, this is not a significant problem. PTT has a more elastic crystalline morphology so the longer fibre culmination link helps stabilize the yarn allowing a manufacture to avoid additional air conditioning costs.

2.3 Quench

Trials using cross flow and radial quenching systems were successful. Radial quenching systems with both inside-to-outside and outside-to-inside airflow have been used successfully. The fibre bundle should be quenched quickly and uniformly to prevent UDY shrinkage in the spun supply cans. Quench temperatures ranging from 8-35° C. have been used, although temperatures of 8-25° C. are preferred. In general, quench airflow rates are limited by operability of the UDY thread path. The number of filaments per position has ranged from 350 to 3500 filaments per position. In fine denier staple production it may be possible to have upwards of 6250 filaments per position with modern radial quenching systems. Optimization of quench systems involves determining which conditions offer the most operability and yield the highest percent elongation for the target UDY creel properties.

2.4 Spin Finish

In this specification all the coatings applied to the PTT fibre during staple extrusion and draw production are defined as spin finishes. Spin finishes are fibre coatings that provide lubrication, cohesion, and additive protection to the PTT fibre during staple production and down stream processing. Both multi-component phosphate and mineral oil based finishes have been used successfully in the production of PTT staple. Proven PET spin finish chemistries and application methods are satisfactory for initial PTT staple products. Spin finish formulations and application methods can then be changed based on customer feedback on staple processing.

2.5 Take-Up

Take up speeds ranging from 900 to 1250 metres per minute have been used for commercial PTT UDY production. On research equipment, take up speeds for UDY have ranged from 500 to 2250 metres per minute. It is useful to take a controlled relaxation between the take-up capstan rolls and sunflower wheel before piddling into the tow can. Cooling all the filaments in a single position to less than 25-30° C. is necessary to minimize UDY shrinkage in the tow can.

3.0 TOW DRAWING AND FINISHING

3.1 UDY Storage

Under normal storage conditions, PTT UDY completes over 90% of its ageing process within 8 hours of extrusion. UDY draw properties stabilize within 24 hours and no significant change in draw properties is observed after 2-4 months of storage at constant temperature. PTT UDY has the potential to shrink more easily and at lower temperatures than PET UDY. Storage conditions warmer than 25-30° C. should be avoided because they trigger UDY shrinkage. Ideally, the PTT UDY creel is stored in an air-conditioned environment to help avoid shrinkage. The exact temperature that triggers PTT UDY shrinkage depends on UDY extrusion, quench, take-up and storage conditions. Even if the PTT UDY shrinks it is possible to convert this UDY into a first grade commercial staple product during draw processing with minor impact on product quality.

3.2 Creel Size

The creel size for PTT staple is determined by the size of the production crimper. In general the creel size for PTT staple is roughly 60% of an equivalent PET staple product because of the higher bulk of PTT fibres. A 600,000 denier drawn tow will satisfactorily feed a 110 mm wide by 20 mm high crimper. This may change as crimper size increases and/or draw production rates increase above 100-130 metres per minute. Since most draw production lines have a maximum line speed of 250-300 m/min, increasing the volume of the crimping chamber is another way to improve draw line productivity.

3.3 Creel and Tow Preparation

Avoid heating the PTT UDY above 25° C. until the UDY tow is under uniform roll tension. This will minimize the shrinkage of PTT feeding the draw process and maintain a uniform fibre tension at all points in the tow cross section during drawing. If uncontrolled, non-uniform UDY shrinkage is allowed, can to can orientation variation will limit draw process uniformity.

Prewet baths before drawing are preferred, but the temperature should not exceed 25° C. unless driven and nipped rolls are provided to minimize tension into the draw feed section. If driven rolls are not available, the bath should be at the lowest uniform temperature possible.

3.4 Drawing Process

PTT staple has been manufactured on draw-relax and draw-anneal process configurations. In the draw relax process the staple is heat treated and dried under zero tension to reduce shrinkage. This process produces a low modulus fibre suitable for PTT spun yarns and blending with low modulus fibres like wool and acrylic. The draw anneal process heat treats the tow on rolls under high tension and produces a higher modulus fibre more suitable for blending with minor amounts of rayon, cotton or other higher modulus fibre.

The initial draw point of the UDY tow in the first draw stage should occur under water heated to a minimum of 60° C., preferably 60 to 100° C. Keeping the draw point hot improves draw process performance by significantly reducing the impact of extrusion conditions on production draw ratios. If desired, the second draw stage is hotter than the first draw stage up to a practical maximum of the melting point of the yarn, preferably 60 to 160° C., most preferably 80-100° C. Unlike PET, PTT will not turn harsh in heated draw baths. Additional draw zones are optional and usually extend the total machine draw ratio slightly. The major draw ratio should be taken in the first stage.

Annealing or relaxing PTT staple tow with a 3% roll relaxation across a set of 100-130° C. calendar rolls increases the initial modulus of the final PTT staple by 12-14%. This process produces a high modulus fibre suitable for PTT spun yarns and blending with high modulus fibres like cotton, rayon, and PET. Initial modulus increases about 4% for every 10° C. from 130-150° C. when the relaxation across the roll set is held at 3%. Annealing PTT tow above 150° C. may require increasing the relaxation across the calendar rolls to avoid excessive filament breakage. Spin finish is often applied to make up for spin finish lost in draw processing using a dip bath or front/back kiss roll application just before the crimping stage.

3.5 Crimping

PTT tow bends very easily compared to PET tow given its low bending modulus. This low modulus also gives PTT excellent hand and softness. Additionally, PTT is much more bulky than PET. Low bending modulus and high bulk require the following changes in crimping conditions:

Dancer roll and crimper roll are reduced to provide more control of crimp geometry.

Feed tow denier must be decreased or crimper volume increased because of PTT's higher bulk. The increased bulkiness of PTT can be accounted for by either decreasing the amount of tow denier feeding to the crimper by most preferably 10 to 60 percent, preferably 40 to 60 percent, all by denier. Another way is to increase the volume of the crimper by 10 to 50 percent, preferably 20 to 35 percent, all by volume. Also, a combination of these two methods can be used.

Ideally, the crimper should be equipped with steam and spin finish injection to better control crimping chamber temperature.

It may be necessary to improve the precision of pressure and temperature control in the crimping chamber.

Crimp stability and take up improve significantly when the crimper chamber is at least 85° C. and at 300 kPa (3 bar) of gate pressure. Crimp frequency may be higher and crimp amplitude lower than comparable PET staple. Crimp stability and take up improves as crimper temperature increases. The crimper should not be heated too much because, as crimp stability increases, so does staple cohesion, which can increase defects in carding.

3.6 Drying, Cutting, and Packaging

Relaxation (drying) of PTT staple in conventional belt ovens is straightforward. However, both crimp geometry and shrinkage characteristics change as the oven temperature is raised above the hottest temperature in the preceding draw process. In draw relax staple production both staple fibre and subsequent spun yarn dry heat shrinkage decrease as the dryer temperature is increased.

In draw anneal staple production the relaxation oven is used as a dryer. The airflow rates are relatively high and the air temperature relatively low (75-90° C.) to facilitate tow drying. These conditions are not hot enough to allow staple fibre relaxation or crimp geometry change. Staple tow has been cut in commercial production using both rotary and pacific converter type cutters without modification. Both gravity and air conveyed staple balers have packaged PTT staple in commercial trials.

4.0 GENERIC RECIPES FOR 1.7, 2.5 AND 3.33 DTEX (1.5, 2.25, AND 3 DPF) STAPLE

Draft recipes for three typical staple products are briefly outlined in the following table. Every staple production facility is different. It will usually take 2-3 attempts on a commercial line to identify a commercial process for PTT staple. These recipes were developed on small commercial production equipment. They may change slightly as processes are scaled up to larger equipment and higher production rates. The UDY is produced using a 253° C. melt temperature at 1100 m/min. To attain these draw ratios requires uniform extrusion conditions such that the filament diameter coefficient of variation is between 3-5% in all spinning positions. Further these draw ratios are obtained in very well controlled, modern process equipment. It is not unusual for older equipment to only attain 75-85% of these draw ratios.

The recipes in table II also describe a high and low shrinkage recipe for each target staple denier. The amount of draw production shrinkage decreases significantly as the first stage draw bath temperature is raised above 60° C. Further the amount of draw production shrinkage decreases slightly as the draw ratio increases. Lastly draw production shrinkage in the crimper and dryer are further reduced when using calendar rolls to anneal the fibre. Commercial product draw production rates of 100-130 metres per minute and development draw rates as high as 225 m/min have been used. The commercial draw relax process typically uses a 70° C. first draw and a 100° C. second draw. The commercial annealed staple process typically uses a 70° C. first draw, a 100° C. second draw, and 130° C. calendar rolls with a 0.95 relaxation.

TABLE II
Draft Recipes for 1.5, 2.25, 3.0 dpf Staple

| | 4.0 | 3.2 | 6.4 | 6.8 | 9.2 | 9.7 |
|---|---|---|---|---|---|---|
| Undrawn Yarn dpf | dTex | dTex | dTex | dTex | dTex | dTex |
| 1^{st} Draw Ratio D2/1 | 2.73 | 2.73 | 2.74 | 2.74 | 2.75 | 2.75 |
| 2^{nd} Draw Ratio D3/2 | 1.10 | 1.10 | 1.15 | 1.15 | 1.20 | 1.20 |
| Machine Draw Ratio | 3.00 | 3.00 | 3.15 | 3.15 | 3.30 | 3.30 |
| Draw Production Relaxation | High | Low | High | Low | High | Low |
| in Crimper & Dryer | | | | | | |
| | 20% | 16% | 18% | 14% | 16% | 12% |
| Final Staple Product | 1.7 | 1.7 | 2.5 | 2.5 | 3.3 | 3.0 |
| | dTex | dTex | dTex | dTex | dTex | dTex |

4.1 STAPLE PROPERTIES

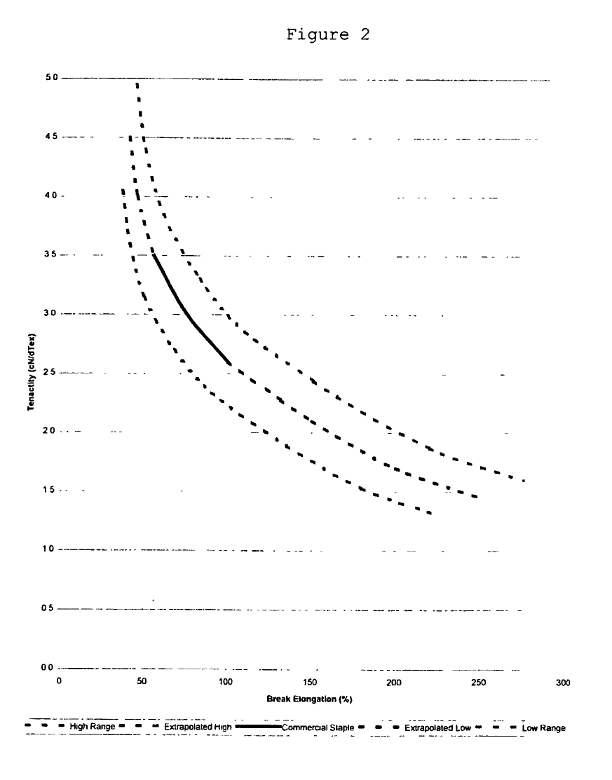

This discussion of tensile properties assumes that the creel stock is drawn to within 90% of tow breakout. A typical draw relax PTT staple fibre will usually have a tenacity of 2.7-3.0 cN/dTex and an elongation between 80-90%. A typical commercial draw annealed staple will have 3.4-3.5 cN/dTex and an elongation between 60-65%. The tenacity elongation balance curve below (FIG. 2) is useful in helping assess the possible range of staple properties for PTT. High tenacity, low elongation PTT staple is very challenging to produce due to rapid relaxation of PTT tow under crimping conditions. Single filament test results on R&D equipment indicate fibre tenacities as high as 4 cN/Tex with 45% elongation. One may be able to produce PTT staple with tenacities greater than 3.5 cN/Tex on a highly optimized draw anneal process. In this effort the control of crimping conditions will be critical.

### EXAMPLE 1

### Controlling Shrinkage of Undrawn Yarn During Extrusion and Storage

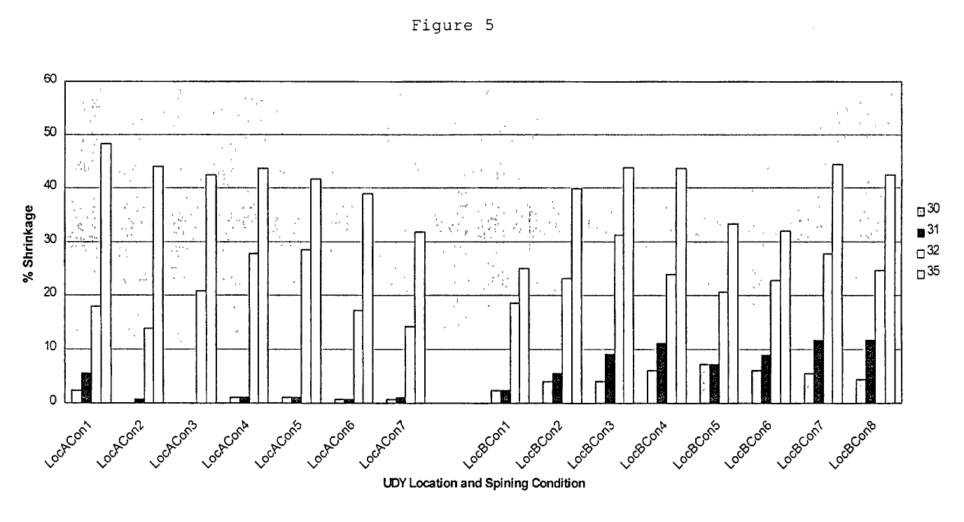

Evaluation of the undrawn yarn shrinkage of PTT UDY spun at two different locations under a wide variety of different conditions. Test results indicate that it is best to store PTT UDY below 31° C. to avoid excessive shrinkage greater than 2-3%, as shown in FIG. 5. This chart shows the percentage shrinkage in undrawn yarn immersed in water baths at several temperatures −30° C., 31° C., 32° C. and 35° C. The spinning conditions covered a range of drawn product denier per filament (dpf) range from 0.8 to 4.5 dpf and the operating range of throughput and takeup speed for different developmental staple production lines one at location A and another at Location B. This chart also shows that PTT UDY shrinkage is more a function of spinning conditions than quench air temperature. Location A uses 25° C. quench air and location B uses 16° C. quench air. Excessive undrawn yarn shrinkage is undesirable because it can increase staple product variability if not properly controlled.

### EXAMPLE 2

### Shrinkage of Staple Process Drawn PTT Ribbons

Summary and Conclusions

Drawing in baths of 60° C. or higher eliminates any effect of spin induced structure on as drawn fibre shrinkage.

Drawn fibre shrinkage decreases with increasing draw bath temperature, but the effect is fairly small at temperatures above 60° C. Shrinkage also decreases with increasing total orientation (Draw Ratio), but the effect is very minimal at the higher draw bath temperatures. When as drawn shrinkage is insensitive to spinning and drawing settings, crimping becomes more stable, and the product less variable. Drawing at temperatures above 60° C. is recommended and should provide stable crimping operation.

Predicted relaxation factors for crimping and drying/relaxing as a function of drier/relaxation temperature were prepared from the shrinkage data. Although the shape of the curve is correct and can be used for extrapolation of known data, the magnitude of the factor appears too high.

It appears unlikely that product shrinkage as a function of drier / relaxation temperature can be predicted from shrinkage data for PTT.

Introduction

The range of spinning conditions examined on the pilot draw line used herein were:

240 to 260° C. block temperature

0.432 to 0.865 g/hole min (0.4 mm capillary)

1000 to 2000 m/min spin speed

These supplies were drawn at three draw ratios:

Breakout Draw Ratio (BODR) minus 0.1

BODR-0.2

BODR-0.4

This, coupled with the large variation in spun orientation, gives a large range of spun orientation.

Three staple draw bath temperatures were used:

40° C.

55° C.

70° C.

This was the maximum practical operable range for the equipment.

Drawn ribbons were completely characterized. The shrinkage results are analyzed below.

Unlike tenacity and elongation, which in PTT, PET, and other melt spun polymers, is primarily a function of total orientation, shrinkage is a much more sophisticated probe of fibre structure, and is affected by orientation and, more importantly, by crystallinity.

The objective of this part of the experiments is to answer the following shrinkage questions, which are presented in their order of importance to process design.

1. Do differences in spin yarn structure persist through drawing, or does the drawing process erase them? This has important implications in the design of spin processes and procedures.

2. How does the draw bath temperature affect shrinkage? Residual shrinkage after drawing is a major factor affecting how easily a fibre can be crimped. In general, fibres with high shrinkage crimp easily. If shrinkage is a strong function of draw bath temperature and orientation, the crimper must frequently be rebalanced to reflect changing draw conditions, and crimping is less uniform.

3. How much shrinkage will occur when a fibre is drawn and crimped and how is it affected by spin and draw conditions? This information is used to calculate the relaxation factor in the spinning model.

4. What additional product shrinkage will exist at higher temperatures when fibre is free relaxed in an oven at a given temperature?

A model that has proven useful for PET has the following premises:

When heated above glass transition temperature, unless restrained, a fiber will shrink until all the amorphous area has deoriented.

As temperature is raised above glass transition, additional oriented amorphous areas appear as crystals melt. These newly created amorphous areas then deorient, providing additional shrinkage. So, in general, the higher the temperature, the higher the shrinkage.

Several definitions, which are somewhat circular in nature, are now required. Glass transition temperature is defined as that temperature at which unrestrained amorphous chains are free to deorient, as required by the second law of thermodynamics. Amorphous areas are those which are not crystalline. Crystalline areas are those which do not deorient at this temperature. There are any number of ways to define crystalline regions in terms of TGA curves, X-ray behavior, density etc, and all give more or less different, but related, answers in terms of % crystalinity. For the purposes of this discussion we will define crystals in terms of their ability to retain orientation at temperature.

Inherent in this model is the assumption that heat treating a rope results only in crystalline melting and fibre deorientation. For PET yarns relaxed in processes with short dwell times, this model works well. It works fairly well for staple processes involving dwell times of several minutes, but its validity for PTT was unknown before this work.

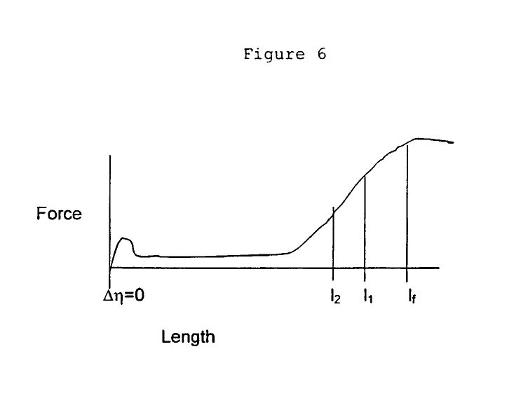

The length, orientation diagram in FIG. 6 can be used to illustrate the process. This diagram represents what happens when you draw a fibre from its length at zero birefringence to the sample fibre length, l_{f}. When this fibre is heated to temperature T₁ it loses length to l₁ because all the amorphous areas deorientate and all crystals that are not stable to T₁ melt and also deorientate.

The fibre does not deorientate completely, because there are still crystals that are stable at T₁. When the temperature is raised to T₂, additional crystals melt, become amorphous, deorientate, and the length decreases further. One would think that it would be possible to shrink completely to zero birefringence draw ratio 1.0, but in practice there are some crystals that are stable to and beyond the melting point, (which causes problems in PET polymerization). These do not deorient and so reorientation can never be complete.

With the above introduction behind us, it is now possible to address the experimental questions. Do differences in spin yarn structure persist through drawing?

One would expect that shrinkage should be a strong function of the draw ratio, because that is what provides the orientation that is lost. With PET, this is true to some degree, but the effect is grossly overshadowed by the fact that as orientation increases, so does the ability to form crystalline areas, so there are opposing effects of orientation increase. Also in PET, at elevated draw bath temperatures, all memory of spinning is erased, in so far as shrinkage is concerned. Orientation can be approximated as the total orientation parameter (TOP) (Denier Draw Ratio/Natural Draw Ratio).

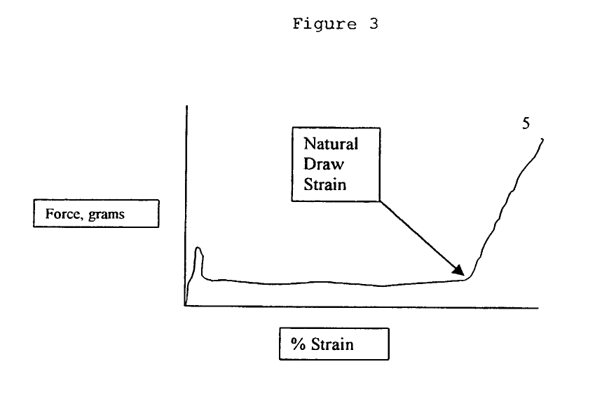

To calculate the natural draw ratio, it is necessary to determine the proper strain rate for the laboratory equipment and skills which would give reproducible results. A single tube spun at 40#hr, 240° C., and 1500 m/min was tested at strain rates from 200 to 800% per minute. Three replicate measurements were performed with the curves traced on a single graph. Results were quite reproducible at all strain rates indicating good laboratory skills and equipment. All determinations gave the characteristic curve illustrated in FIG. 3. Natural draw ratio can be calculated easily from these plots as follows:

NDR=1+(S_{n/}100) (1)

where:

Sₙ is % Strain at the Natural Draw Strain

This is equivalent to the classic definition of NDR which is:

NDR=l_{d}/lₛ (2)

where:

l_{d} is the length at the natural draw point of inflection

lₛ is the length of the spun sample.

The first step is to establish what variables are statistically significant in predicting shrinkage at a given temperature. The procedure was to use the stepwise forward and stepwise backward regression procedures in Sigma Stat 2.0 with F to enter >4.0 and P to reject <0.05.

Results summarised in Table III indicate:

Both procedures were in general agreement.

At draw temperatures of 60° C. or higher, spinning variables play no significant role in drawn fibre shrinkage.

Total Orientation Parameter and, surprisingly, block temperature were weakly significant factors in shrinkage at the 45° C. draw temperature.

It is concluded that draw temperatures of 60° C. or higher should be used to wipe out any spinning effects on product shrinkage. This data supports the hypothesis that, like PET, spinning structure is wiped out if a draw temperature significantly above T_{g} is used. Regression equations for correlations with r²>0.5 are reported below the Table. Note that there are no such for T>=60° C.

TABLE III
Regression Analysis of Ribbon Shrinkage

| Draw Bath | | | | | |
|---|---|---|---|---|---|
| Temperature, | | Forward Test | | Backward Test | |
| ° C. | Shrinkage | Variables | r² | Variables | r² |
| 45 | Boil Off | TOP, T_{b} | 0.666 | TOP, T_{b} | 0.666⁽¹⁾ |
| ″ | 125° C. | TOP, T_{b} | 0.695 | TOP, T_{b} | 0.695⁽²⁾ |
| ″ | 140° C. | TOP, T_{b} | 0.540 | TOP, T_{b} | 0.540⁽³⁾ |
| ″ | 175° C. | TOP, T_{b} | 0.489 | TOP, T_{b} | 0.441 |
| ″ | 197° C. | TOP | 0.126 | TOP | 0.126 |
| 60 | Boil Off | Qₕ | 0.190 | Qₕ | 0.153 |
| ″ | 125° C. | TOP | 0.188 | Qₕ | 0.131 |
| ″ | 140° C. | TOP | 0.241 | TOP | 0.241 |
| ″ | 175° C. | AVE | na | AVE | na |
| ″ | 197° C. | AVE | na | AVE | na |
| 75 | Boil Off | AVE | na | AVE | na |
| ″ | 125° C. | Qₕ, Sₘ | 0.273 | Qₕ, Sₘ | 0.273 |
| ″ | 140° C. | AVE | na | AVE | na |
| ″ | 175° C. | AVE | na | AVE | na |
| ″ | 197° C. | AVE | na | AVE | na |

TOP = Total Orientation Parameter = (Denier Draw Ratio/Natural Draw Ratio)
T_{b} = Block Temperature, ° C.
Qₕ = Hole Throughput, g/hole minute
Sₘ = Spinning Speed, metres/minute
AVE = All Independent Variables Eliminated

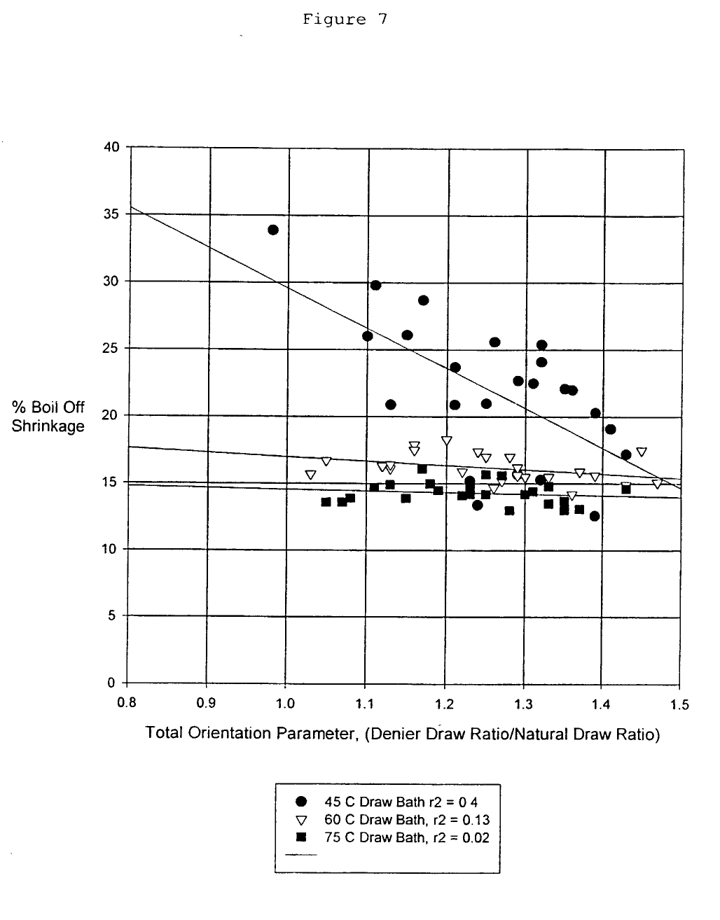

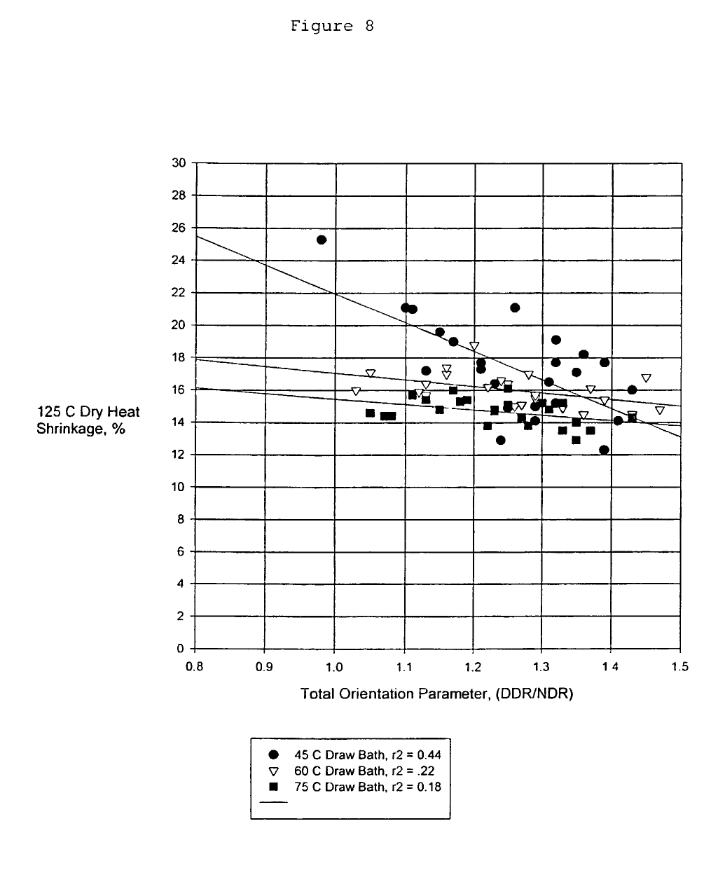

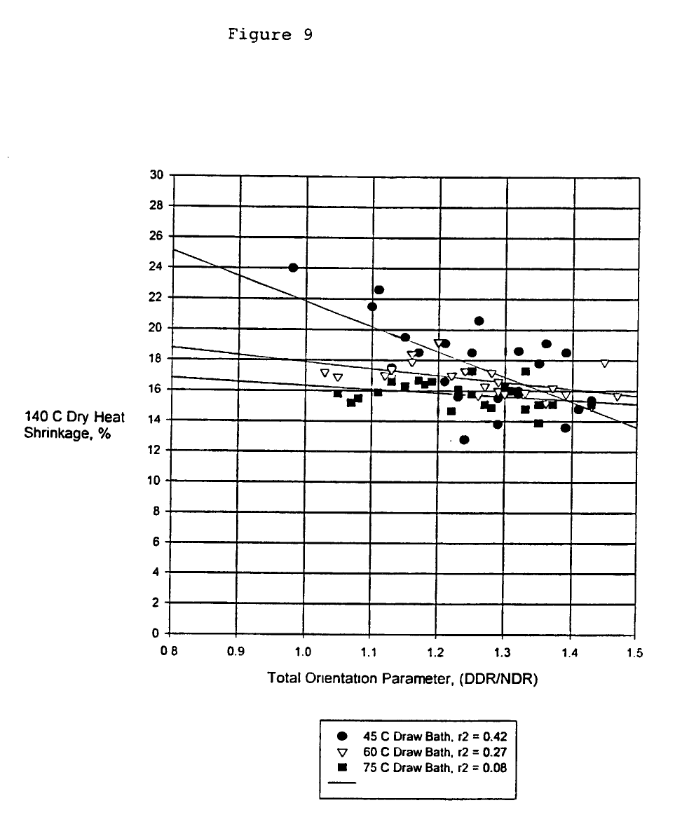

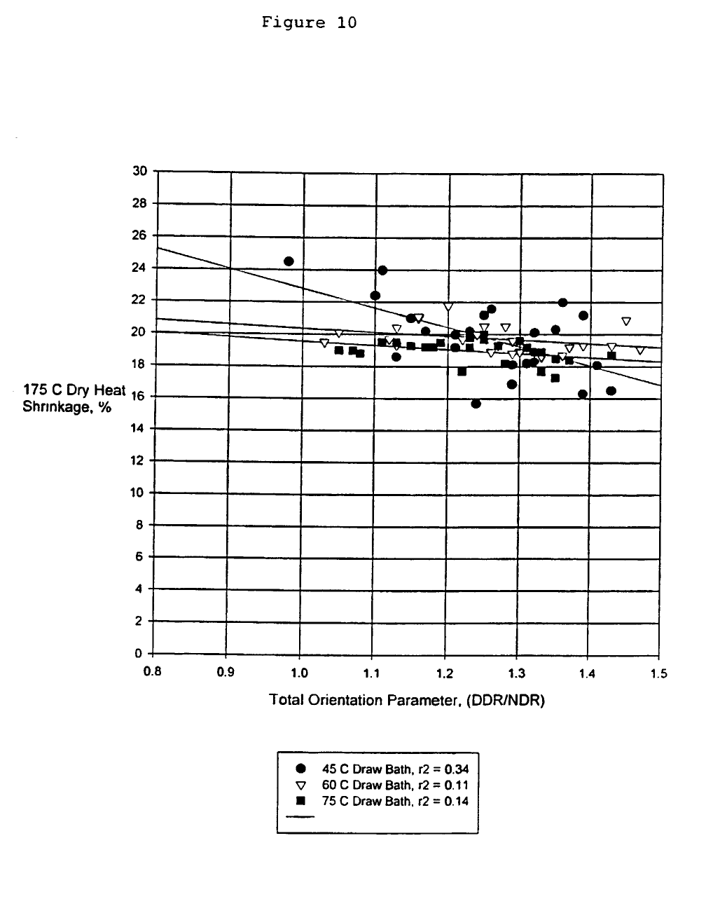

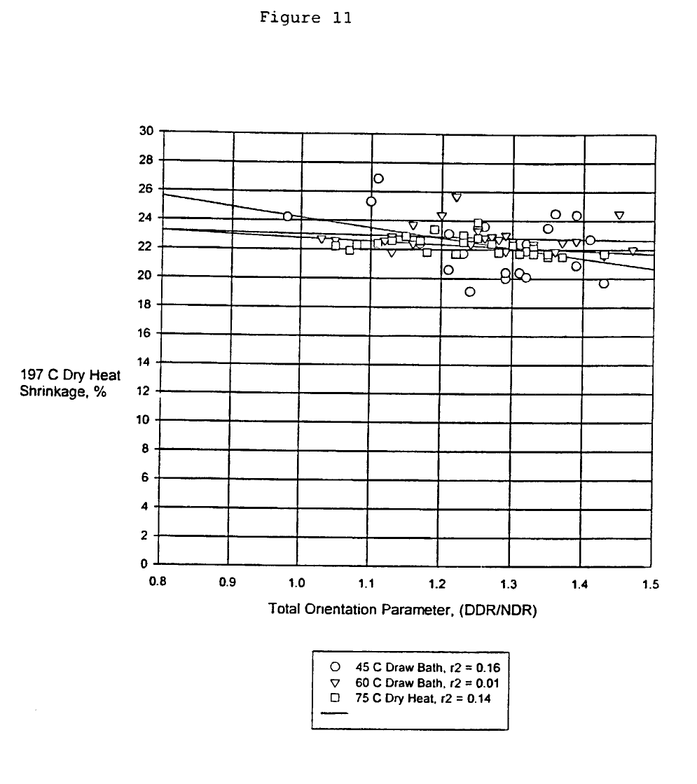

How does the draw bath temperature affect shrinkage? FIGS. 7 through 11 are plots of Boil Off Shrinkage, and Dry Heat Shrinkage at 125, 140, 175, and 197° C., for the three draw bath temperatures used. It is clear that there is a large mechanism change between 45 and 60° C., the-next higher temperature tested. At temperatures greater than 60° C. shrinkage is nearly independent of orientation, and relatively insensitive to bath temperature.

Higher bath temperatures do decrease shrinkage potential a small amount, but not significantly in terms of crimping potential or probable product performance.

Operation at temperatures of 60° C. or higher is recommended because crimper operation is greatly simplified. Crimper adjustments under these conditions are not required except to compensate for denier density into the crimper (denier/linear crimper inch, dtex/linear crimper cm).

How does spinning and draw bath temperature affect the relaxation factor? FIGS. 7 through 11, and the analysis of variance, indicate that shrinkage potential of drawn rope is independent of spinning conditions and only weakly dependent on orientation, except for the lowest temperature examined, 45° C.

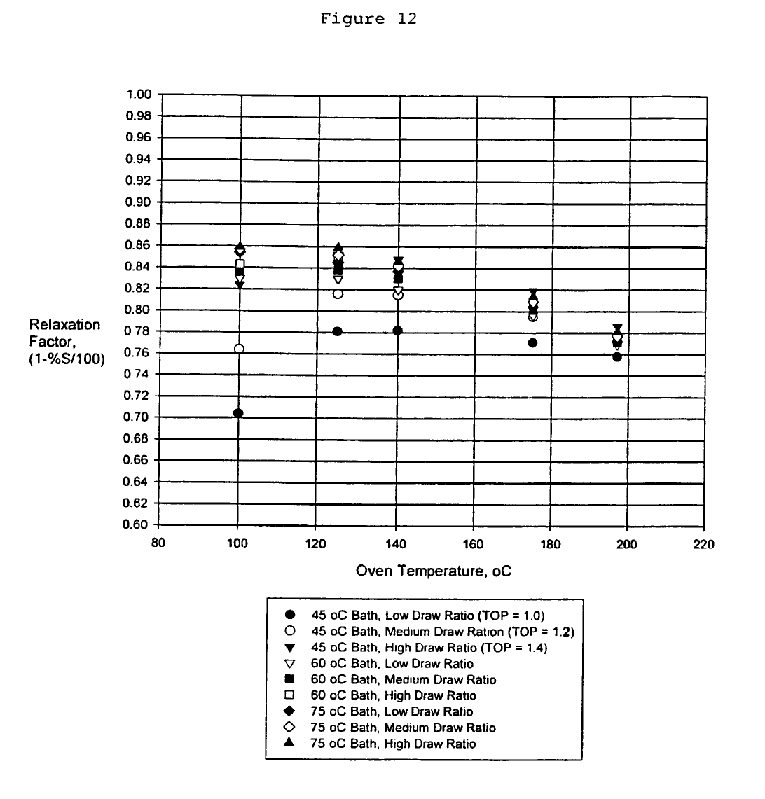

FIG. 12 shows the relationship between oven temperature and relaxation factor for drawn ropes. At draw bath temperatures above 60° C. a line through the top grouping of data points should approximate the relaxation factor. This is a good starting point, but the value may be too high (shrinkage too low) because the shrinkage method uses a small weight on the sample so it is not completely free to relax as it would in a typical plant drier/relaxer.

However, the curve should have the correct shape and therefore be good enough to extrapolate the temperature effect when more machine specific data is obtained.

Can relaxed product shrinkage be predicted from the ribbon shrinkage data?

Referring to FIG. 3 and the simple shrinkage model for PET it is found that if a fibre at l_{f} is put in an oven at T₁, it will lose amorphous orientation and some of the crystals will melt and deorientate and its length will decrease to length l₁. Similarly, if a sample of length l_{f} is placed in an oven at T₂, which is higher than T₁, it will shrink more because more of the crystalline material will melt at the higher temperature and shrink to length l₂.

Mathematically, the shrinkage may be expressed in the following way:

Let:

Φ₁=% Shrinkage @T₁/100 (1)

Φ₂=% Shrinkage @T₂/100 (2)

Then, from the definition of Dry Heat Shrinkage:

Φ₁=(l_{f}−l₁)/l_{f}=1−l₁/l_{f} (3)

Φ₂=1−l₂/l_{f} (4)

What would happen if the sample free relaxed at T₁ is tested it for shrinkage at T₂? If no crystalline growth or change other than melting and deorientation takes place during the first shrinkage process, it should shrink to l₂.

The first shrinkage, then, is what the fibre experiences in the relaxer, and the second shrinkage is the residual shrinkage in the relaxed product. To some degree PET follows these assumptions so it is possible to estimate relaxed product shrinkage from the dry heat shrinkage of drawn ribbons.

To do this what must be calculated is the shrinkage when the product shrunk at T₁ is shrunk a second time at T₂. This can be done by the using the definition of shrinkage and FIG. 3 as follows:

Φₚₛ=(% shrinkage of sample shrunk at T₁ when shrunk at T₂)/100 (5)

Φₚₛ=(l₁−l₂)/l₁=1−l₂/ l₁ (6)

If equations 3 and 4 are used to eliminate l₁ and l₂ in terms of the measured dry heat shrinkages at the two different temperatures this leads to:

Φₚₛ=1−(1−Φ₂)/(1−Φ₁) (7)

From this, and the measured shrinkages, the expected product shrinkage at T₂ after an oven relaxation at T₁ can be calculated.

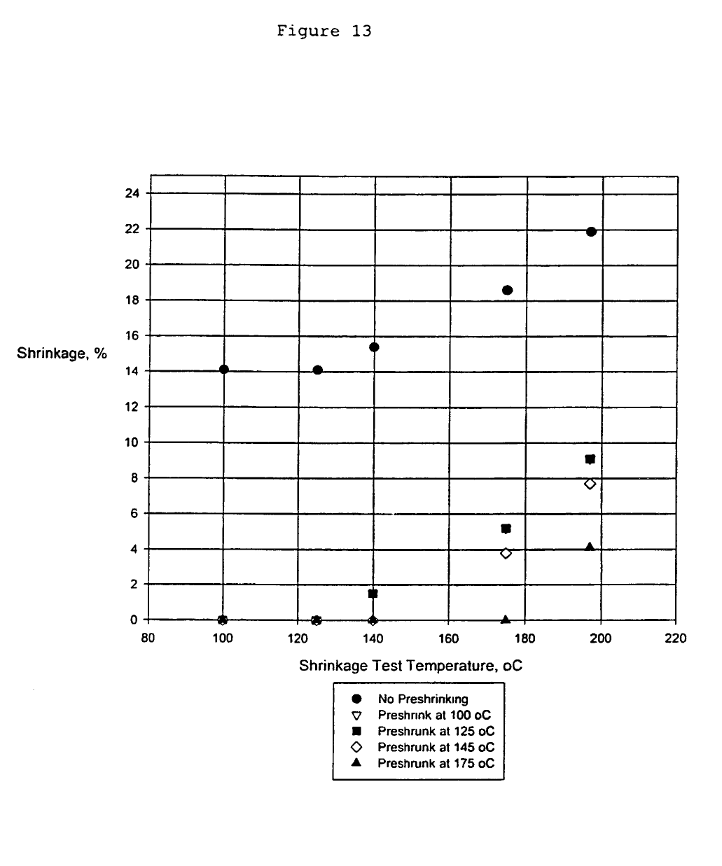

FIG. 13 is a plot of predicted shrinkage for the technical useful case of high orientation, and high bath temperature. It appears that the predicted fibre shrinkages after a given oven relaxation are much too low. This indicates that significant crystalline change in addition to simple deorientation occurs in the drier/relaxer.

### EXAMPLE 3

### Evaluation of PTT Staple Fiber Heat Setting on the Properties on PTT Spun Yarn Properties under Heated Strain Conditions: Yarns Evaluated included PTT, PTT/PET Blend, PTT/Cotton Blend, and PET (Table IV)

Breakage of filaments during the extrusion of PTT synthetic fibres severely limits production productivity and product quality. PTT resins with IV in the range of 0.55-1.0 are preferred, more preferably those with IV range of 0.675-0.92, and most preferably those with IV range of 0.72-0.82. Producing PTT synthetic fibres with an intrinsic viscosity range of 0.72-0.82 helps improve synthetic fibre production operability and product quality without a significant reduction in final fibre properties.

Reducing the intrinsic viscosity of PTT helps:

1. Reduce the amount of change in the viscosity of the chip compared to the viscosity of the extruded fibre.

2. Improve the homogeneity of polymer melt in the spin pack. PTT resin with 0.92 IV requires more severe spin pack filtration systems to maintain marginal yields in extrusion.

3. Improve production operability by decreasing the number of broken filaments during production.

4. Allow one to run the product with cooler extrusion temperatures for extruded filaments having less than 2-denier per filament. PTT is known to degrade at melt extrusion temperature above 260° C. When producing fine denier synthetic filament (filaments with less than 2 dpf) using 0.92 IV resin one has to increase the melt extrusion temperature to reduce the melt viscosity enough to avoid excessive melt flow turbulence and melt degradation which cause filaments to break during extrusion.

5. Reduce the amount of shrinkage in the product fibre making it easier to draw process and/or wind on to stable yarn packages.

Staple yarns made from PTT are surprisingly elastic—having recoverable elasticity when extended up to 15-25% of the original yarn length. This elasticity is also present in staple yarns produced from intimate and non-intimate fibre blends where PTT is the major fibre component by weight and/or length. Further, this elasticity is recoverable after several hundred cycles. The elasticity is sufficient enough to enhance the shape retention characteristics of textile fabrics produced from PTT staple yarns and blended staple yarns. Properly constructed and finished fabrics that contain a majority of PTT staple spun yarn (by weight of length percent) can have surprisingly high elastic recovery in woven and knit fabrics (tested with over 500 cycles by hand and 200 by instrument). The present invention covers the formation of staple spun yarns by conversion of staple into a twisted yarn structure by any method. The spun yarn can be made by hand, spinning wheel, ring-spinning, open-end spinning, air-jet spinning or other types of staple to yarn conversion equipment.

Staple yarns made from cotton, wool, acrylic, PET are not elastic. In order to produce staple yarns from these fibres that are elastic the industry commonly has to add an elastic continuous filament either internally to the yarn or fabric to give the final textile product elastic properties. These solutions are more expensive than a basic staple spun yarn made from PTT. The value of the present invention is that people with basic staple spun yarn technologies can produce an elastic spun yarn of commercial value without investing in more expensive core spun yarn equipment or incorporating elastic continuous filaments into the fabric structures, which then complicates how the fabric is dyed and finished.

An effort was made to briefly characterize how staple fiber heat setting properties impacts the behavior of yarns made from PTT staple and PTT staple blended with cotton, and PTT staple blended with PET staple. As noted in Table IV, the PET and cotton blend yarn were prepared from several PTT staple supplies produced with differing relaxer temperature and having significantly different crimp. So, the effect of blending with other fibers cannot be definitely ascertained. Caution should therefore be used in inferring precise blend level effects from these experiments. This experiment looks at each of the example yarns in terms of shrinkage, modulus, stress decay and recovery. These factors are generally independent and were studied separately in this work.

TABLE IV
Fiber Properties

| Item Number | PTT5-CR1-2 | PTT5-CR1-3 | PTT-CR1-4 |
|---|---|---|---|
| Fiber Relaxation Oven | 105 | 120 | 135 |
| Temp ° C. | | | |
| Fiber Denier/Filament | 1.75 | 1.80 | 1.79 |
| Tenacity, cN/dtex | 3.52 | 3.49 | 3.24 |
| Elongation to Break, % | 48 | 45 | 44 |
| Load at 10% Strain, | 0.83 | 1.21 | 1.13 |
| cN/dtex | | | |
| Hand Crimp Index, % | 28 | 19 | 18.5 |
| Crimp/inch | 14.8 | 15.8 | 14.2 |
| Yarn Produced | 100% PTT | 50% PTT and | 50% PTT and |
| | | 50% Cotton | 50% PET |

Summary and Conclusions

For Spun Yarn 175° C. Dry Heat Shrinkage

Spun yarn dry heat shrinkage decreased with oven temperature for all blends tested (100% PTT, 100% PET, 50/50 PTT/PET, and 50/50 PTT/Cotton).

Dry heat shrinkage increases approximately ½% for each % applied stretch (or relaxation) for all blends tested.

PTT spun yarn shrinkage was 2 to 2½% less than PET yarns.

PTT data closely followed the amorphous deorientation model for shrinkage.

For Spun Yarn Boil off Shrinkage

Boil off shrinkage decreased with oven temperature for all blends tested.

Boil off shrinkage increases about 0.4% for each 1% applied stretch for all blends tested.

PTT spun yarns were about 1% lower than PET yarns in boil off shrinkage, because they were made by the draw relax process whereas the PET sample was draw anneal.

For Spun Yarn Load at 5% Strain (Stretch)

Fabrics are perceived as “stretchy” when very little force is required to change their length a significant amount. In this set of trials we choose to characterize stretch by observing the force required to strain the fabric 5%. The major variable affecting all blends tested was applied stretch. Oven temperature was much less important, this evaluation indicates:

PTT exhibited 3-4 times less force to elongate 5% (greater stretch) than PET.

The amount PTT's stretch decreases with applied stretch is 1/10th that of PET (0.01 gpd increase/1% stretch vs 0.1) Therefore applied stretch can be used for PTT to modify yarn properties without a large yarn stretch penalty.

The stretch of 100% PTT yarn was relatively insensitive to heat set conditions.

Spun Yarn Stress Decay

How much a yarn or fabric will recover after being subjected to a given strain for a given length of time depends on two factors:

1. How much stress decay occurs while the strain is maintained.

2. The amount of recovery after the strain is released.

These factors are generally independent and were studied separately in this work:

PTT stress decay was independent of heat set temperature and decreased linearly with increasing applied stretch (0.5% reduction in stress decay/1% applied stretch in heat setting).

PET stress decay decreased with increasing oven temperature and linearly with increasing applied stretch. The applied stretch effect is considerably stronger than with PTT (−0.9% per % applied stretch).

PTT and PET exhibited roughly the same amount of stress decay.

PTT/PET blend yarns behaved about half way between the corresponding pure yarns with a −0.7% decrease per % applied stretch.

PTT/Cotton blend yarn stress decay was independent of heat setting conditions.

Spun Yarn Recovery

Recovery for the PTT yarns from this sample set was much less than that observed for the pre-commercial yarn sample recently tested having 98% recovery. The cause for this may be the 100° C. drier oven used in fiber processing. The principal heat set variable affecting recovery for all samples tested was applied stretch, with increasing applied stretch increasing recovery:

PTT recovery increases 0.9% per 1% applied stretch

PTT generally had 5 to 10% higher recovery than PET

PTT/Cotton blend data was very erratic but exhibited the same general trends as the pure yarns.

Shrinkage Fundamentals

In a semi crystalline polymer fiber with significant orientation, the orientation resides in two areas, the crystalline areas, and the amorphous areas connecting the crystalline domains. There is usually a range of crystal sizes, and the orientation of crystalline regions can vary.

When a fiber is exposed to temperatures below the glass transition temperature, length change is very slow and is called creep. In general, useful textile fibers all have low rates of creep in the absence of load. When the fiber is heated to temperatures above Tg, the amorphous areas become mobile and in the absence of a restraining force, deorient as closely as they can to the isotropic state (no preferential orientation). The isotropic state is favored by the second law of thermodynamics. This usually results in shrinkage, but in rare instances the crystalline regions are collapsed upon themselves and there is “negative” orientation so the fiber grows. Such fibers are called self elongatable. It is not known if they can be made from PTT. The crystalline regions are not mobile, and do not deorient.

As one continues to increase the temperature of the fiber, smaller crystals melt and their domain becomes amorphous. They now deorient and additional shrinkage occurs. This is why shrinkage generally increases with temperature for a semi crystalline polymer. So there are two strategies for reducing fiber shrinkage:

1. Preshrink to the temperature at which you want the fiber to be stable

2. Crystallize under heat and tension at a temperature which yields crystals stable at the temperature at which you do not want the fiber to shrink.

For commodity PET fiber, where the issues are spinning and weaving efficiency and yarn strength, the second route is exclusively used, because as we will see later, preshrinking reduces fiber modulus. Specialty fibers, particularly for wool blends, use the first route because strength and modulus are not important issues, but the better dyeability offered by route 1 is an advantage. At this juncture, it is not clear which is the better route for PTT.

If a fiber is stretched, its amorphous orientation increases, and so does shrinkage. In PET untwisted continuous filament yarn there is often nearly a 1 to 1 correspondence (5% stretch increases shrinkage 5%).

So far we have been discussed single uncrimped fibers. The situation for spun yarn is more complex because:

Fibers are twisted at a helix angle which reduces the effect of fiber shrinkage on the yarn

Fibers migrate from outside to the middle of the yarn

Fibers can slip in the yarn

The presence of blend fibers with different shrinkages can change the shrinkage of the assembly.

Even with these complexities, we can use the simple model to predict responses of a spun yarn to heat setting conditions:

1. If the yarn is heated and allowed to free relax, it should deorient and crystallinity should increase. Both factors decrease shrinkage. At a constant oven temperature, the shrinkage decrease should be linear with the relaxation. Shrinkage should decrease with increasing oven temperature.

2. If a yarn is heated and held at constant length there is no deorientation. Shrinkage decreases with increasing oven temperature as long as the yarn treatment oven temperature is higher than the fiber experienced during the free to relax step in fiber manufacture.

3. If a yarn is heated and stretched, orientation increases and therefore so should shrinkage. Shrinkage should increase linearly with applied stretch, and decrease with increasing oven temperature, providing that it is higher than that seen during fiber processing.

With this foundation in place, we are now ready to analyze the effect of heat setting conditions on yarn shrinkage.

175° C. Spun Yarn Dry Heat Shrinkage

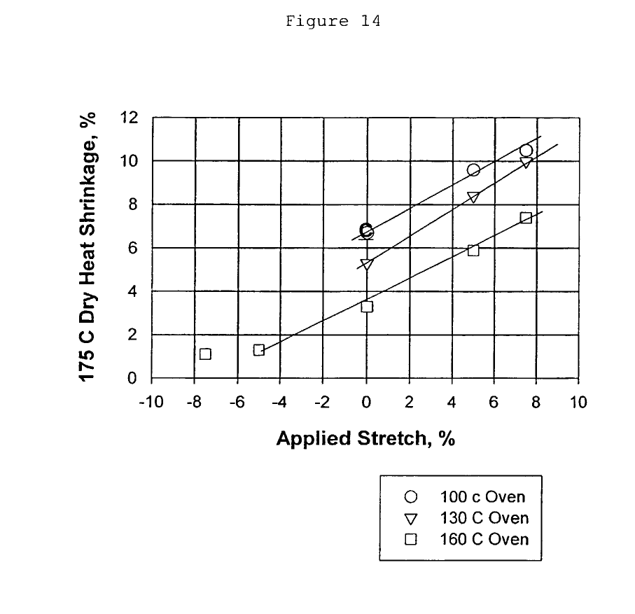

As illustrated in FIG. 14, PTT is a wonderful substrate that follows all the rules of the total orientation model.

At 0% applied stretch the control which was relaxed at 100° C. has exactly the same shrinkage as the yarn treated at 100° C. When treated at higher temperatures, still at constant length, the shrinkage decreases.

As length is changed by applied stretch, or shrinkage, the shrinkage increases linearly with applied stretch, and the slopes are roughly constant with oven temperature. At a given oven temperature 176° C. dry heat shrinkage increases about 0.46% per 1% applied stretch.

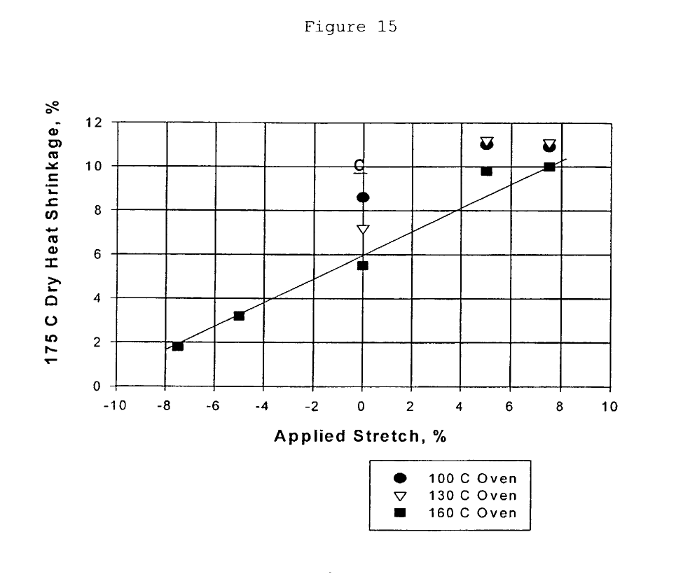

PET behaves in a similar manner, FIG. 15. Because it is an annealed, and not a relaxed fiber, shrinkage of the control yarn decreases with increasing oven temperature even at 100° C. Because it is high modulus, at high stretch and low oven temperature the fibers do not stretch, but slip in the yarns so the shrinkage increase is not so great as for PTT. For oven temperatures above 130° C. PET dry heat shrinkage increases about 0.55% per 1% applied stretch. This is somewhat higher that PTT, but a good rule of thumb for both is ½% shrinkage increase for each % stretch.

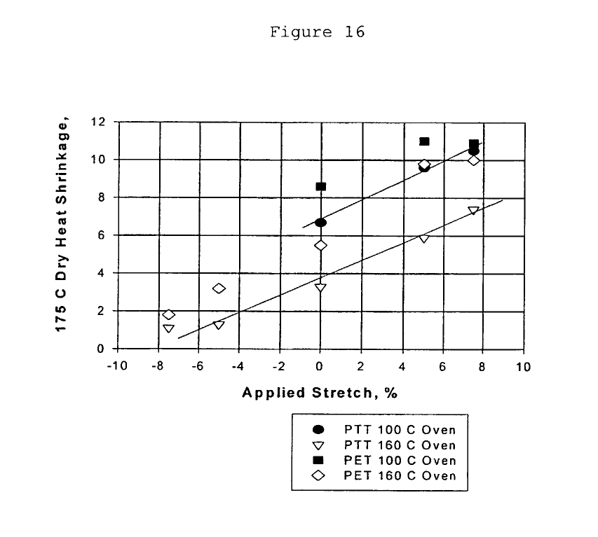

FIG. 16 compares PTT and PET yarn shrinkage for the highest and lowest heat set temperatures. PTT has about 2 to 2 ½% lower dry heat shrinkage than PET for equivalent oven conditions. As mentioned above both have roughly the same increase in shrinkage with applied stretch.

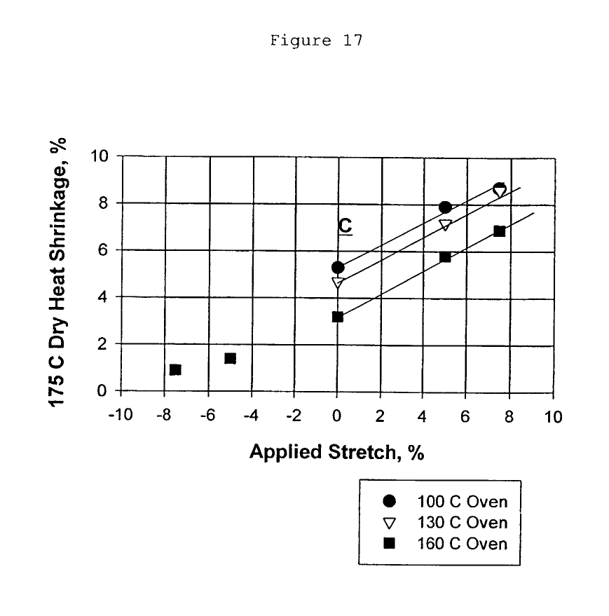

The PTT/Cotton blend is similar to the PET blend (FIG. 17) with shrinkage increasing with decreased oven temperature and increasing applied stretch. The increase with applied stretch is fairly linear and shrinkage increases roughly 0.47% per 1% applied stretch. Shrinkage of the cotton blends is approximately 1% less than the PET blend for similar conditions. For this sample set a good rule of thumb is that 1% applied stretch increases dry heat shrinkage ½%

Spun Yarn Boil Off Shrinkage

Boil off shrinkage behaves in the same way as dry heat, except that the amorphous orientation available is that present in the fiber plus all crystals which melt between the glass transition and 100° C., so it is much less than the dry heat shrinkage. In some fibers where the plastization effect of water is high, this shrinkage can be considerable. Fibers produce by a draw relax process with relaxation temperatures above 100° C. generally have very low boil off shrinkages. Annealed fibers generally have relatively high boil off shrinkage because they are heated under tension and there is always amorphous orientation present.

These samples in general followed these principles. All blends behaved in a manner similar to dry heat shrinkage with shrinkage decreasing with increasing oven temperature, and increasing with applied stretch.

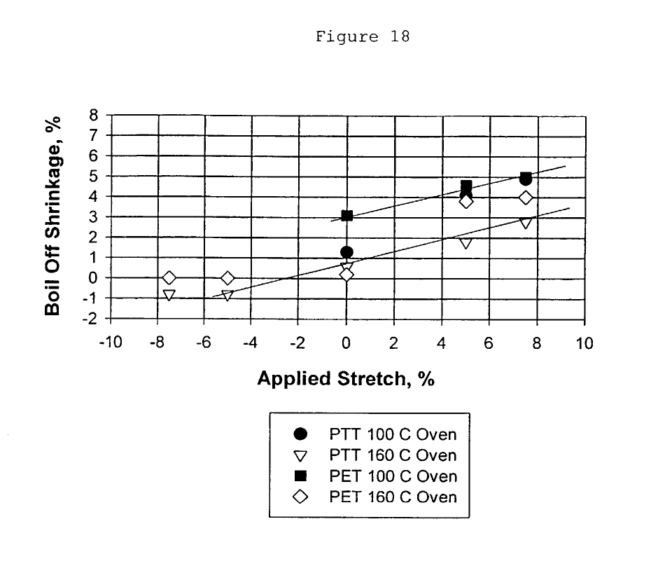

The PTT control yarn had a shrinkage of 2% even though the fibers which went into it were oven relaxed at 100 C. This indicates that some cold drawing occurred in processing, probably during carding. This is not unexpected, given PTT's low modulus. PTT yarn shrinkage increased about 0.38% per 1% applied stretch. The control PET yarn had considerably higher shrinkage than PTT (4.5 vs 2%) because it is produced by the annealing process. Yarn shrinkage increased 0.47% per 1% applied stretch. In general PTT yarns have approximately 1% less dry heat shrinkage than PET yarns given similar yarn heat setting conditions (FIG. 18).

The PTT/PET blend yarns had a shrinkage increase of 0.44% per 1% applied stretch, and the PTT/Cotton yarn hand an increase of 0.417. A good rule of thumb for boil off shrinkage is that it increases about 0.4% per 1% applied stretch for all conditions tested.

For 100% PTT spun yarns, load at 5% strain is nearly independent of oven temperature, and is linearly related to applied stretch increasing 0.01 gpd per 1% increase in applied stretch. This means that yarn stretch decreases as the yarn is drawn during heat setting. Note for the PTT data that the control yarn, which was produced from fibers relaxed at 100100% has essentially the same load at 5% strain as that heat set at 0 stretch and 100° C.

PET yarns behaved in a similar manner. In this case there was a considerable change for the control yarn vs yarn heat set at 100° C and 0 applied stretch because the feed fibers were annealed, not relaxed. PET load at 5% elongation increases an order of magnitude higher than PTT with applied stretch, 0.1 gpd/1% applied stretch.

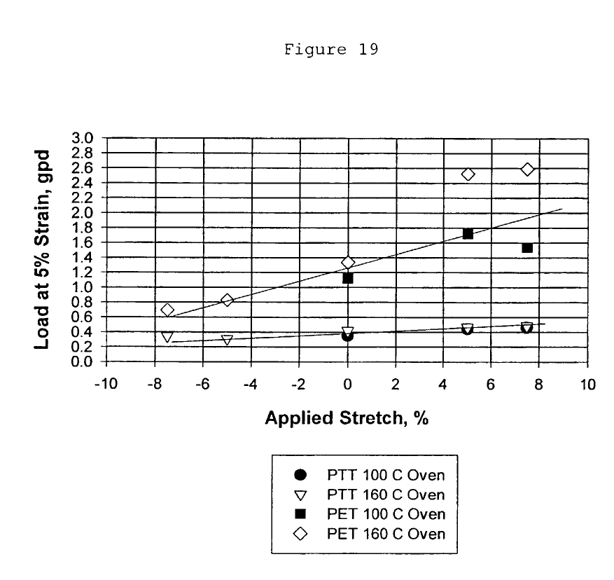

FIG. 19 compares the behavior of PTT and PET, and PTT's stretch advantage is strikingly apparent. Not only is the force required for 5% strain a factor of 3 lower with no applied stretch, the response to applied stretch is much less, which means applied stretch can be used in heat setting PTT yarns without paying an excessive price in yarn stretch. Interestingly the highest applied stretch PTT item (7.5%) requires 45% less force at 5% strain than a PET sample which is relaxed 7.5%.

Spun Yarn Stress Decay

How much strain a yarn or fabric will recover after being strained and held at constant length for a period of time depends on two factors:

How much stress decay occurs while the sample is held at constant length. In the extreme, if all the stress is lost, the recovery will be zero.

How much strain is recovered after the test time period.

This spun yarn stress decay experiment involved straining the yarn 5%, then holding the spun yarn at length for 2 minutes and allowing the yarn to recover to zero stress. Stress decay was calculated manually from the test charts, and is somewhat less accurate than machine calculated numbers from computerized analysis methods. Stress decay and recovery are two separate phenomena and are discussed separately.

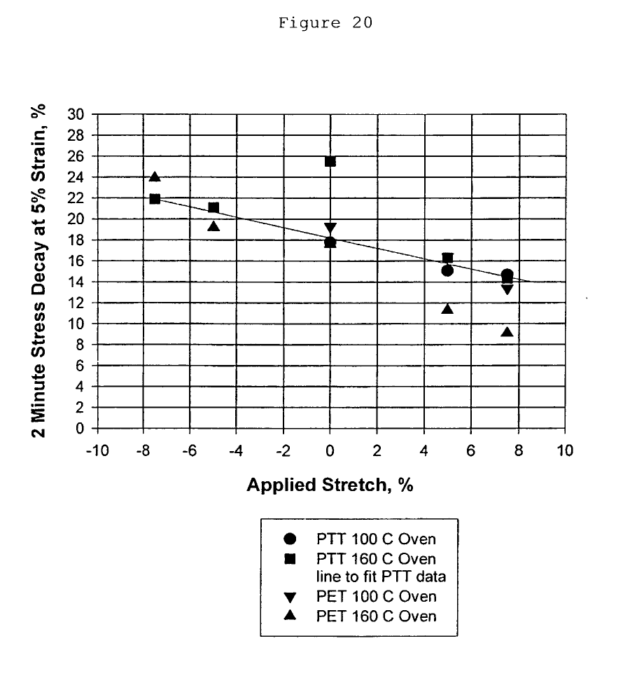

Stress decay of 100% PTT yarns was independent of oven temperature and decreased linearly with applied stretch. While intuitively it is believed stress decay should increase with applied stretch, the r2 for this correlation is quite high. PTT stress decay decreases about 0.5% per % applied stretch. PET yarn behaved in a similar way although there is a definite oven temperature effect, and the decrease per unit applied stretch (0.9% decay/1% applied stretch) is nearly double that of PTT. FIG. 20 compares PTT and PET stress decay. In general PET is higher at low applied stretch, and lower than PTT at high oven temperature and applied stretch. The behavior of the PTT/PET blend is half way between the two pure fibers with less oven temperature sensitivity and a 0.7% stress decay decrease per 1% applied stretch. Stress decay for the PTT/Cotton blends was independent of heat setting conditions.

Spun Yarn Recovery

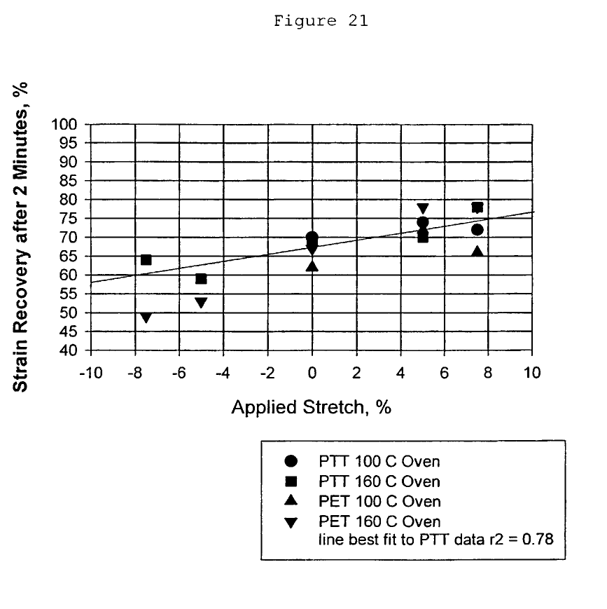

PTT recovery was not affected by oven temperature and increased linearly with increasing applied stretch (0.9% recovery per 1% applied stretch). PET recovery increased marginally with increase in oven temperature but the principal effect was applied stretch. Its response is much more pronounced than for PTT with an increase of 2.2% recovery for each 1% applied stretch. As indicated in FIG. 21, PTT generally has 5-10% higher recovery than PET except where PET has had high levels of applied stretch in a high temperature oven. The PTT/PET blend yarn responded like pure PTT with no oven temperature dependence and a strong response to applies stretch (1.7% increase in recovery for each 1% applied stretch. PTT/Cotton blend results were erratic with both higher oven temper and higher applied stretch increasing recovery.

Property Trade Off in Spun Yarn Heat Setting

One of the primary reasons for doing this work is to answer the question: “If heat setting the yarn to reduce its shrinkage then how much does stretch, recovery and stress decay deteriorate?”. To answer this question for this data set it is necessary to plot these variables against each other. Since all variables are dependent variables, the relationships hold true only for this data set and others in which the dependent variables were changed in the same manner as we did here. With this caveat let us observe the responses:

For the stretch/dry heat shrinkage tradeoff, stretch increases (load at 5% strain decreases) as dry heat shrinkage is decreased. This is a favorable trade since there is no stretch penalty to be paid by reducing shrinkage by letting the yarn shrink. Although the r2 is quite low at 0.47, considering that every point is included, this data is probably a reliable trend guide. Load at 5% decreases 0.01 gpd for each 1% reduction in shrinkage.

The recovery/dry heat shrinkage tradeoff is unfavorable. Recovery decreases 1.3% for each 1% reduction in dryheat shrinkage. r2 for this data was a respectable 0.64.

The stress decay/dry heat shrinkage tradeoff is unfavorable with stress decay increasing 0.9% for each 1% reduction in dry heat shrinkage. It is believed this increase in stress decay is responsible for the reduction in recovery. In any case dry heat shrinkage should only be reduced the minimal amount required by the end user.

### EXAMPLE 4

### Lowering Resin PTT Resin IV from 0.92 to 0.82 Provides Improved Extrusion Reliability in PTT Staple Production

Breakage of filaments during the extrusion of PTT synthetic fibers severely limits production productivity and product quality. Producing PTT synthetic fibers with an intrinsic viscosity range of 0.72-0.82 helps improve synthetic fiber production operability and product quality without a significant reduction in final fiber properties.

Reducing the intrinsic viscosity of PTT helps reduce the amount of change in the viscosity of the chip compared to the viscosity of the extruded fiber. It also improves the homogeneity of polymer melt in the spin pack. PTT resin with 0.92 IV requires more severe spin pack filtration systems to maintain marginal yields in extrusion. It also helps improve production operability by decreasing the number of broken filaments during production. It allows one to run the product with cooler extrusion temperatures for extruded filaments having less than 2-denier per filament. PTT is known to degrade at melt extrusion temperature above 260° C. When producing fine denier synthetic filament (filaments with less than 2 dpf) using 0.92 IV resin one has to increase the melt extrusion temperature to reduce the melt viscosity enough to avoid excessive melt flow turbulence and melt degradation that results in which cause filaments to break during extrusion. It also reduces the amount of shrinkage in the product fiber making it easier to draw process and/or wind onto stable yarn packages.

1. A process for making textile staple fibre from polytrimethylene terephthalate (PTT) on existing PET textile staple fibre making equipment which comprises:
(a) melt extruding PTT polymer at 245 to 253° C.,
(b) spinning the extruded PTT into yarn using at least one spinneret,
(c) moving the spun yarn to a first takeup roll wherein the distance from the spinneret to the first takeup roll is from 16 to 20 feet,
(d) cooling the spun yarn to less than 31° C. before it reaches the first takeup roll,
(e) optionally, storing the spun yarn at a temperature of no more than 31° C.,
(f) prior to the draw process, preconditioning the yarn under tension at a temperature of at least 60° C.,
(g) drawing the yarn at a temperature of at least 60° C.,
(h) optionally, allowing the drawn yarn to relax at a temperature of up to 190° C., and
(i) crimping the drawn yarn at a temperature of 70 to 120° C. and decreasing the drawn yarn feed rate by 10 to 60 percent by denier from the drawn yarn feed rate used for making comparable PET.

2. The process of claim 1 wherein the intrinsic viscosity of the PTT is from 0.55 to 1.0.

3. The process of claim 2 wherein the intrinsic viscosity of the PTT is from 0.72 to 0.82.

4. The process of claim 1, 2 or 3 wherein the spun yarn is cooled to less than 25° C. before it reaches the first takeup roll.

5. The process of claim 1 wherein the relaxation step is not used and the crimping temperature is 70 to 100° C.

6. The process of claim 1 wherein the relaxation step is used and the crimping temperature is 80 to 120° C.

7. The process of any one of the preceding claims wherein step (i) further comprises using a crimper volume of 10 to 50 percent more than the crimper volume of the crimper used to make comparable PET.

8. The process of any one of the preceding claims wherein the drawn yarn feed rate is decreased by 40 to 60 percent.

9. A process for making textile staple fibre from polytrimethylene terephthalate (PTT) on existing PET textile staple fibre making equipment which comprises:
(a) melt extruding PTT polymer at 245 to 253° C.,
(b) spinning the extruded PTT into yarn using at least one spinneret,
(c) moving the spun yarn to a first takeup roll wherein the distance from the spinneret to the first takeup roll is from 16 to 20 feet,
(d) cooling the spun yarn to less than 31° C. before it reaches the first takeup roll,
(e) optionally, storing the spun yarn at a temperature of no more than 31° C.,
(f) prior to the draw process, preconditioning the yarn under tension at a temperature of at least 60° C.,
(g) drawing the yarn at a temperature of at least 60° C.,
(h) optionally, allowing the drawn yarn to relax at a temperature of up to 190° C., and
(i) crimping the drawn yarn at a temperature of 70 to 120° C. and using a crimper volume of 10 to 50 percent more than the crimper volume of crimper used to make comparable PET.

10. The process of any one of the preceding claims wherein step (g) involves at least two draws, the first carried out at least 60° C. and the second and subsequent draws, if any, carried out at a higher temperature than the first up to the melting point of the yarn.
